(19) United States
(12) Patent Application Publication
(10) Pub. No.: US 2014/0333154 A1
(43) Pub. Date: Nov. 13, 2014

(54) MULTISTAGE FERROFLUID SEALING APPARATUS FOR SUPERCONDUCTING ROTATING MACHINES

(71) Applicants: Hyun-Jang Shin, Yongin-si (KR); Byung-San Baek, Suwon-si (KR); Keun-Woong Kim, Yongin-si (KR)

(72) Inventors: Hyun-Jang Shin, Yongin-si (KR); Byung-San Baek, Suwon-si (KR); Keun-Woong Kim, Yongin-si (KR)

(73) Assignee: HYUNDAI HEAVY INDUSTRIES CO., LTD., Ulsan (KR)

(21) Appl. No.: 14/128,087

(22) PCT Filed: Jul. 11, 2012
(86) PCT No.: PCT/KR2012/005496

§ 371 Date: Dec. 20, 2013

(30) Foreign Application Priority Data
Jan. 27, 2012 (KR) 10-2012-0008611

(51) Int. Cl. H02K 1/02; H02K 5/04; H02K 1/06

(52) U.S. Cl. CPC H02K 1/02; H02K 1/06; H02K 5/04
USPC 310/11

(57) ABSTRACT

Disclosed is a multistage magnetic fluid sealing apparatus for superconducting rotating machines. According to the present invention, the magnetic fluid sealing apparatus, which is provided with a first magnetic fluid chamber and a second magnetic fluid chamber that are arranged in a multi-stage manner so as to contain a magnetic fluid capable of sealing the inner portion of a superconducting rotating machines, is installed on one surface of the superconducting rotating machines. The free magnetic fluid sealing apparatus of the invention configured to have a dual structure enables two to three fluid lines to be installed in the superconducting rotating machines.

### TECHNICAL FIELD

The present invention relates to a multistage ferrofluid sealing apparatus for a superconducting rotating machines, and more particularly, to a magnetic fluid sealing apparatus for a superconducting rotating machines, wherein the magnetic fluid sealing apparatus which can seal the inner portion of a superconducting rotating machines is installed on one surface of the superconducting rotating machines, and thus two or three fluid lines can be installed in the superconducting rotating machines due to a multistage structure of the free fluid sealing apparatus.

### BACKGROUND ART

Generally, superconducting rotating machines includes a field coil which is formed of a superconducting wire instead of a copper wire.

Since the superconducting rotating machines include the superconducting wire, it is possible to reduce a loss by half compared to a conventional normal conducting motor or generator, and it is also possible to produce twice capacity in the same size.

Further, since it is possible to produce twice capacity in the same size, its uses are gradually and variously increased from small-capacity generators to large-capacity industrial motors or generators, and the capacity thereof is also increased largely.

The superconducting rotating machines using the superconducting wire includes a hollow rotational shaft, a case which has inner and outer rotational cylinders disposed at the outer circumferential surface of the rotational shaft and having small and large diameters, respectively, a superconducting filed coil which is installed at the inner and outer rotational cylinders, a stator, a cooling rod which cools the superconducting field coil using coolant supplied from the outside, and a magnetic fluid sealing apparatus which maintains consistently a vacuum state inside the case.

Since the ferrofluid sealing apparatus installed in the superconducting rotating machines should seal the inner portion of the case while maintaining its own rotation, a magnetic fluid seal is used mainly.

That is, the magnetic fluid sealing apparatus installed in the superconducting rotating machines functions to previously prevent external air from being introduced into the case through the coolant introduced into and discharged from the inner portion of the case by using magnetic materials and magnetic fluid.

However, in a conventional magnetic fluid sealing apparatus, there is a limitation that only one fluid line is installed at the superconducting rotating machines.

Since only one fluid line is connected to the magnetic fluid sealing apparatus coupled to one surface of the superconducting rotating machines, two or three fluid lines cannot be connected to a newly developed large-capacity superconducting rotating machines.

That is, in the large-capacity industrial superconducting rotating machines, since only one fluid line is connected to the magnetic fluid sealing apparatus coupled to one surface of the superconducting rotating machines, the coolant cannot be supplied sufficiently to the inner portion of the superconducting rotating machines.

### DISCLOSURE

### Technical Problem

The present invention is directed to providing a multistage magnetic fluid sealing apparatus for a superconducting rotating machines, in which first and second magnetic fluid chambers containing magnetic fluids for sealing are formed in a multistage manner in a central shaft and a housing of the magnetic fluid sealing apparatus so that at least two or three fluid lines can be connected to the magnetic fluid sealing apparatus installed at one surface of a case, and also it is possible to consistently maintain a sealing state of the superconducting rotating machines, even though multistage fluid lines are installed.

### Technical Solution

One aspect of the present invention provides a multistage magnetic fluid sealing apparatus for a superconducting rotating machines which includes a sealing chamber that allows sealing by magnetic fluid, and a magnetic fluid sealing apparatus that is configured by a central shaft and a housing having first and second fluid passage holes through which coolant is supplied and collected, including a first magnetic fluid chamber containing magnetic fluid for sealing and formed at a center of the central shaft; and a second magnetic fluid chamber containing magnetic fluid for sealing and formed at a center of the housing, wherein the magnetic fluid chambers for sealing are formed in a multistage manner.

In the first magnetic fluid chamber, ring-shaped first and second fluid passage grooves capable of containing magnetic fluid and a magnet may be formed in inner and outer surfaces of the central shaft to be corresponding to each other.

Ring-shaped third and fourth fluid passage grooves capable of containing magnetic fluid and a magnet may be formed in inner and outer surfaces of the housing to be corresponding to each other.

### Advantageous Effects

According to the present invention as described above, since a first magnetic fluid chamber having first and second fluid passage grooves and a second magnetic fluid chamber having third and fourth fluid passage grooves, on which magnetic fluids for sealing can be attached, are formed in a multistage manner at a central shaft and housing of a magnetic fluid sealing apparatus, two or three fluid lines can be connected to the magnetic fluid sealing apparatus, and thus it is possible to increase sealability and smoothly supply coolant to a superconducting rotating machines, and it is also possible to previously prevent damage of the superconducting rotating machines and decrease in electricity generation amount thereof.

### DESCRIPTION OF DRAWINGS

FIG. 1 is a perspective view partially cut away illustrating a multistage magnetic fluid sealing apparatus for a superconducting rotating machines according to an embodiment of the present invention.

FIG. 2 is a partially enlarged perspective view partially cut away illustrating the multistage magnetic fluid sealing apparatus for the superconducting rotating machines according to the embodiment of the present invention.

FIG. 3 is a partially enlarged cross-sectional view the multistage magnetic fluid sealing apparatus for the superconducting rotating machines according to the embodiment of the present invention.

### MODES OF THE INVENTION

Hereinafter, exemplary embodiments of the present invention will be described in detail with reference to the accompanying drawings.

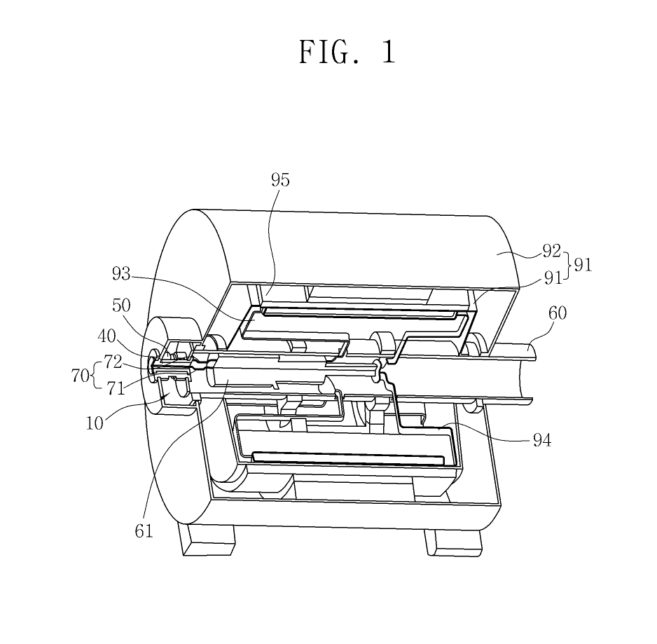

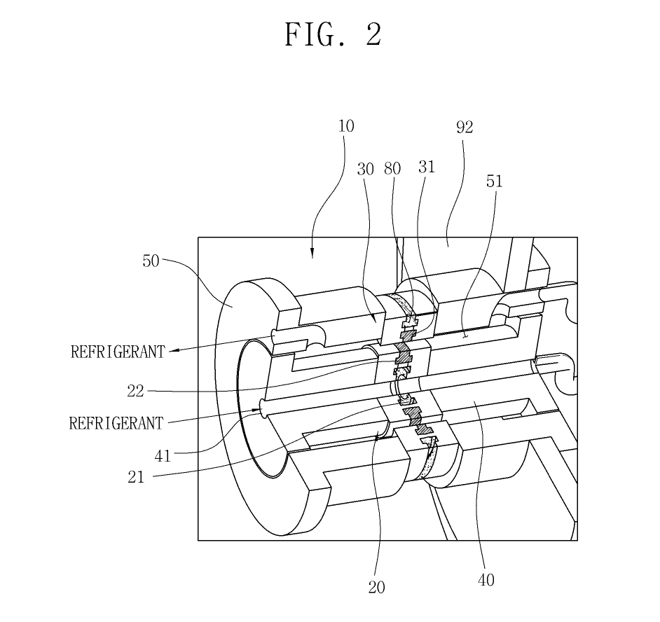

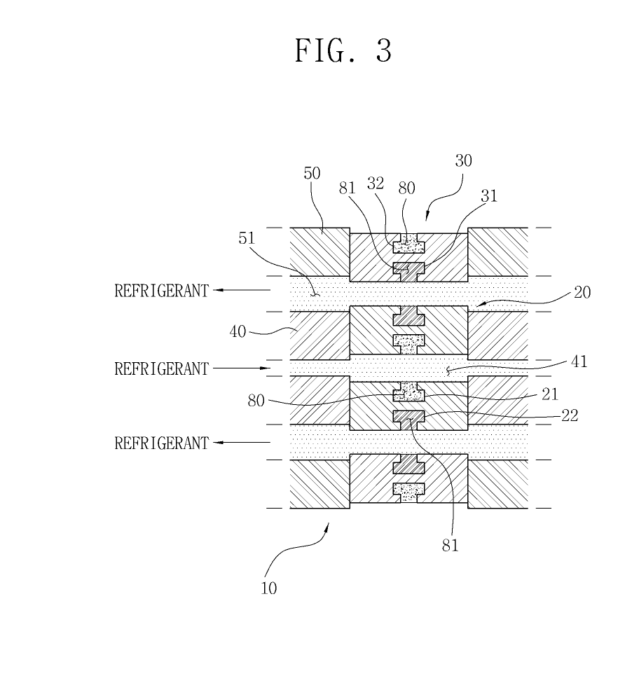

FIG. 1 is a perspective view partially cut away illustrating a multistage magnetic fluid sealing apparatus for a superconducting rotating machines according to an embodiment of the present invention, FIG. 2 is a partially enlarged perspective view partially cut away illustrating the multistage magnetic fluid sealing apparatus for the superconducting rotating machines according to the embodiment of the present invention, and FIG. 3 is a partially enlarged cross-sectional view the multistage magnetic fluid sealing apparatus for the superconducting rotating machines according to the embodiment of the present invention.

Referring to FIGS. 1 to 3, in a multistage magnetic fluid sealing apparatus for a superconducting rotating machines according to the present invention including a sealing chamber which allows sealing by magnetic fluid 80, and a magnetic fluid sealing apparatus 10 which is configured by a central shaft 40 and a housing 50 having first and second fluid passage holes 41 and 51 through which coolant is supplied and collected, a first fluid passage holes chamber 20 containing magnetic fluid 80 for sealing is formed at the center of the central shaft 40, and a second magnetic fluid chamber 30 containing magnetic fluid 80 for sealing is formed at the center of the housing 50.

At this time, as shown in FIG. 2, the second fluid passage hole 51 is formed between the central shaft 40 and the housing 50.

The first magnetic fluid chamber 20 formed at the central shaft 40 has a first fluid passage groove 21 containing the magnetic fluid 80 and formed in an inner surface of the central shaft 40, and a second fluid passage groove 22 containing a magnet 81 and formed in an outer surface of the central shaft 40 so as to be corresponding to the first fluid passage groove 21.

The second magnetic fluid chamber 30 formed at the housing 50 has a fourth fluid passage groove 32 containing the magnetic fluid 80, and a third fluid passage groove 31 containing a magnet 81 and formed in an inner surface of the housing 50 so as to be corresponding to the fourth fluid passage groove 32.

Here, the magnetic fluid is a colloidal solution containing iron powder, and magnetic flux is generated in the colloidal solution by the magnets 81 contained in each of the second and third fluid passage grooves 22 and 31, and thus the colloidal solution performs a sealing function.

Since the first and second magnetic fluid chambers 20 and 30 containing the magnetic fluids 80 are provided in a multistage manner at the central shaft 40 and the housing 50 forming the magnetic fluid sealing apparatus 10, it is possible to prevent deterioration of a vacuum state in a case 90 of a superconducting rotating machines due to coolant supplied to and discharged from the case 90, even though not shown in the drawings.

At this time, the coolant supplied through the first and second fluid passage holes 41 and 51 may be directly supplied to or discharged from a cooling rod 61 which will be described later, and also may be supplied to or discharged from the cooling rod 61 through a connection tube 70 having first and second connection tubes 71 and 72 installed at the first and second fluid passage holes 41 and 51 to separately supply the coolant. In the present invention, for example, it will be described that the coolant is supplied to the cooling rod 61 through the connection tube 70.

As shown in FIG. 1, the superconducting rotating machines having the magnetic fluid sealing apparatus 10 installed at one surface thereof includes a hollow rotational shaft in which the cooling rod 61 is installed, and a case 90 which has inner and outer rotational cylinders 91 and 92 disposed at an outer circumferential surface of the rotational shaft 60 and having small and large diameters, respectively.

In the inner rotational cylinder 91, a superconducting field coil 93 using a superconducting coil is supported by a field coil supporting portion 94. A stator is installed in the outer rotational cylinder 92.

A heat shield 95 for blocking radiant heat generated from an inner portion of the case 90 is coupled between the inner and outer rotational cylinders 91 and 92.

At this time, a high vacuum layer is formed between the inner and outer rotational cylinders 91 and 92.

Hereinafter, the operation states and effects of the embodiment of the present invention will be described with reference to FIGS. 1 to 3. First of all, the coolant supplied from a coolant supplying device is supplied to the cooling rod 61 through the first connection tube 71 in order to cool the superconducting field coil 93 and heat shield 95 disposed in the inner and outer rotational cylinders 91 and 92, and the superconducting field coil 93 is rotated by using external power, and thus the superconducting rotating machines produces electric power.

Then, the coolant introduced into the case 90 at the same time when the superconducting rotating machines produces electric power is introduced to the coolant supplying device through the second connection tube 72, even though not shown in the drawings.

At this time, the vacuum state in the case 90 is maintained consistently by the magnetic fluid 80 contained in the magnetic fluid sealing apparatus 10 installed at one surface of the case 90 to be not rotated. Since the first and second magnetic fluid chambers 20 and 30 containing the magnetic fluid 80 are formed in the multistage manner in the magnetic fluid sealing apparatus 10, it is possible to prevent external air from being introduced through the coolant into the case 90 of the superconducting rotating machines.

In other words, since the first magnetic fluid chamber 20 having the first and second fluid passage grooves 21 and 22 containing the magnetic fluid 80 and magnet 81 is formed at the central shaft 40, it is prevented as much as possible that the external air is introduced into the case 90 together with the coolant supplied through the first fluid passage hole 41 formed in the central shaft 40.

And the second magnetic fluid chamber 30 having the third and fourth fluid passage grooves 31 and 32 containing the magnetic fluid 80 and magnet 81 is formed at the housing 50, and thus it is possible to prevent deterioration of the vacuum state in the case 90 when the coolant is collected to the coolant supplying device through the second fluid passage hole 51 formed between the central shaft 40 and the housing 50.

Since the first magnetic fluid chamber 20 having the first and second fluid passage grooves 21 and 22, and the second magnetic fluid chamber 30 having the third and fourth fluid passage grooves 31 and 32 are formed at the central shaft 40 and housing 50 of the magnetic fluid sealing apparatus 10, two or three fluid lines may be connected.

Further, since the first and second magnetic fluid chambers 20 and 30 having a multistage structure are formed in the magnetic fluid sealing apparatus 10, it is possible to prevent external air from being discharged from and introduced into the case 90 of the superconducting rotating machines due to the first and second magnetic fluid chambers 20 and 30, thereby efficiently maintaining the vacuum state in the case 90 and thus preventing decrease in electricity generation amount of the superconducting rotating machines.

Also, since the first and second magnetic fluid chambers 20 and 30 containing the magnetic fluids 80 are formed in the multistage manner in the magnetic fluid sealing apparatus 10, it is possible to produce and provide a large capacity superconducting rotating machines according to development of industry, thereby increasing production of electricity.

Until now, the technical spirit of the multistage magnetic fluid sealing apparatus for the superconducting rotating machines according to the present invention is described with reference to the drawings, but the present invention is not limited to this. While the present invention has been described in detail, it should be understood that various changes, substitutions and alterations can be made hereto without departing from the spirit and scope of the invention as defined by the appended claims.

### Industrial Applicability

According to the present invention, since the first and second magnetic fluid chambers containing magnetic fluids for sealing are formed in a multistage manner in the central shaft and housing of the magnetic fluid sealing apparatus so that at least two or three fluid lines can be connected to the magnetic fluid sealing apparatus installed at one surface of the case, it is possible to smoothly supply coolant to the superconducting rotating machines, and also the present invention can be efficiently applied to the multistage magnetic fluid sealing apparatus for the superconducting rotating machines of which a sealing state should be maintained consistently even though multistage fluid lines are installed.

1. A multistage magnetic fluid sealing apparatus for a superconducting rotating machines which comprises a sealing chamber that allows sealing by magnetic fluid, and a magnetic fluid sealing apparatus that is configured by a central shaft and a housing having first and second fluid passage holes through which coolant is supplied and collected, comprising:
a first magnetic fluid chamber containing the magnetic fluid for sealing and formed at a center of the central shaft; and
a second magnetic fluid chamber containing the magnetic fluid for sealing and formed at a center of the housing,
wherein the magnetic fluid chambers for sealing are formed in a multistage manner.

2. The multistage magnetic fluid sealing apparatus of claim 1, wherein, in the first magnetic fluid chamber, ring-shaped first and second fluid passage grooves capable of containing the magnetic fluid and a magnet are formed in inner and outer surfaces of the central shaft to be corresponding to each other.

3. The multistage magnetic fluid sealing apparatus of claim 1, wherein ring-shaped third and fourth fluid passage grooves capable of containing the magnetic fluid and a magnet are formed in inner and outer surfaces of the housing to be corresponding to each other.
